(19) United States
(12) Patent Application Publication
(10) Pub. No.: US 2002/0132110 A1
(43) Pub. Date: Sep. 19, 2002

(54) Repositionable/ultra removable transfer tape

(76) Inventor: Stan Serwon, Tonawanda, NY (US)

Correspondence Address: Michael F. Scalise, Hodgson Russ LLP, One M&T Plaza, Suite 2000, Buffalo, NY, 14203-2391, US

(21) Appl. No.: 09/811,902

(22) Filed: Mar. 19, 2001

(51) Int. Cl. B32B 7/12; B32B 15/04

(52) U.S. Cl. 428/343; 428/352; 428/355 R

(57) ABSTRACT

The present invention provides a transfer tape of a first layer containing a high aggressive tack and a second layer contains a less aggressive tack. This construction provides the tape being adhered to a support surface such as a form or document, and capable of being repositioned on a second surface without affecting the form or document.

### FIELD OF THE INVENTION

This invention relates generally to a laminate adhesive having an aggressive adhesive on one side, while the other side has a less aggressive adhesive, such as a repositionable adhesive, and the processes of making the same. The film has good adhesive properties including structural integrity at the laminate joint.

### DESCRIPTION OF PRIOR ART

The construction of the laminate adhesive is a composite which has various applicability including a number of press-down applications. The art in this area describes several layers being contacted together to form a multi-layered pressure sensitive adhesive.

Specifically, U.S. Pat. No. 6,017,624 to Delgado describes a pressure sensitive adhesive film as a laminate where a first layer of adhesive is coated to a release substrate and heat cured. A subsequent second layer of microspheres is applied on top of the first layer. This provides a film having a first major surface which was in contact with the release substrate and is generally smoother than the opposite second major surface. Since the second major surface is somewhat bumpier than the first major surface, it provides a lesser peel adhesion than the opposite surface. The problem with a second film of microspheres contacted to a relatively smooth first layer is that it provides a relatively weak bond at the interface which, consequently, is prone to separation failure.

U.S. Pat. No. 5,372,865 to Arakawa et al. describes a double sided pressure sensitive tape, each side having different tensile strengths. One of the adhesive layers comprises an acrylic or rubber-based material having a silicone polymer provided therein. This provides for easily separating the pressure sensitive layers from each other.

U.S. Pat. No. 6,083,616 to Dressler discloses the use of a differential height barrier deposited on one side of an adhesive layer to assist in the location of the object before final-press down.

U.S. Pat. No. 6,001,471 to Bries et al. describes the use of a double sided stretchable adhesive tape having a backing layer supporting opposed adhesive layers of the same or different pressure-sensitive adhesives. This construction provides for controlling the timing of the debonding of both adhesives so that one adhesive surface releases before the other.

While the prior art adhesive tapes are useful, there is a need to produce a double sided transfer tape having a first side of a relatively low tack adhesive and a second side of a relatively aggressive adhesive. This provides a tape which is useful for permanently mounting to a first support surface while a second object or support surface is repositionably adhered to the other side of the tape.

### SUMMARY OF THE INVENTION

The present invention provides such a tape of two layers of different tackiness or aggressiveness contacted together or contacted to an intermediate carrier. The exterior surface of the first layer contains an aggressive tack whereas the exterior surface of the second layer contains a less aggressive tack capable of repositioning without affecting the form or document to which the laminate adhesive is contacted.

These and other aspects of the present invention will become more apparent to those skilled in the art by reference to the following description and to the appended drawings.

### BRIEF DESCRIPTION OF THE DRAWINGS

FIG. 1 is an exploded, cross-sectional view of a transfer tape 10 according to the present invention.

FIG. 2 is schematic of a process for providing another embodiment of a transfer tape 40 according to the present invention.

FIG. 3 is a cross-sectional view along line 3-3 of FIG. 2.

FIG. 4 is a cross-sectional view along line 4-4 of FIG. 2.

FIG. 5 is a cross-sectional view along line 5-5 of FIG. 2.

FIG. 6 is a schematic of another process for providing another embodiment of a transfer tape 70 according to the present invention.

FIG. 7 is a cross-sectional view along line 7-7 of FIG. 6.

FIG. 8 is a cross-sectional view along line 8-8 of FIG. 7.

### BEST MODE FOR CARRYING OUT THE INVENTION

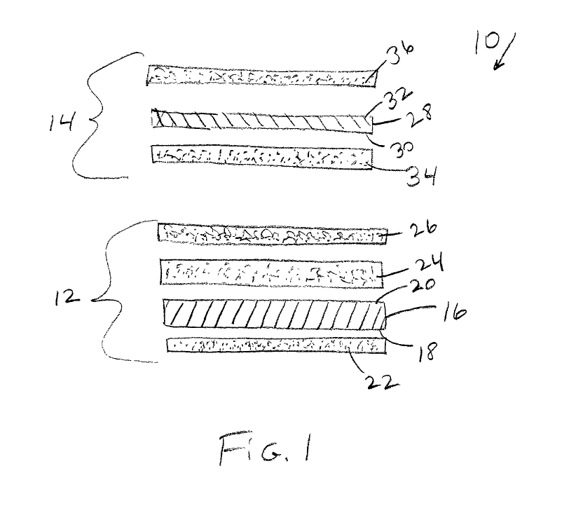

Turning now to the drawings, FIG. 1 is an exploded, cross-sectional view of one embodiment of a repositionable/ultra removable transfer tape 10 according to the present invention. The transfer tape generally includes a face sheet system 12 and a liner sheet system 14. The face sheet system 12 comprises a carrier or substrate 16 having opposed first and second major surfaces 18 and 20. The carrier 16 is a polymeric film of a polyolefin such as polyester, polypropylene or polyethylene, or it can be of a paper material. A preferred material for the carrier 16 is a 92 gauge (1 mil) Jindal or Granwell clear PET. If desired, a pigment is added to the carrier material.

A relatively aggressive adhesive layer 22 is bonded to the first major surface 18 of the carrier 16. The aggressive adhesive 22 is selected from the group of a water based, solvent based or hot melt adhesive, for example, acrylic adhesives or rubber-based (latex) adhesives. Preferably, the aggressive adhesive has a loop tack of ≧30 oz./in², and more preferably from about 80 oz./in² to about 100 oz./in².

The second major surface 20 of the carrier 16 supports an intermediate tie coat 24 and a relatively low tack or repositionable adhesive layer 26. The tie coat 24 serves as a primer layer and comprises a silica or pigment material mixed with an acrylic resin to provide a high energy surface for connecting the low tack adhesive 26 to the carrier 16.

The repositionable or low tack adhesive 26 is an acrylic or latex based material having a loop tack of ≦30 oz./in², and more preferably from about 7 oz./in² to about 10 oz./in².

Thus, the face sheet system 12 of the present transfer tape 10 comprises the carrier 16 having the aggressive adhesive 22 bonded to its first major surface 18. The tie coat 24 is bonded to the opposite, second major surface 20 of the carrier 16, with the tie coat 24 supporting the repositionable adhesive 26.

The present transfer tape 10 further comprises the liner sheet system 14 which includes a liner or substrate 28 having opposed first and second major surfaces 30 and 32. The liner 28 is a polymeric film of a polyolefin such as polyester, polypropylene or polyethylene, or it can be of a paper material. Preferably, the liner 28 is from about 2.0 to 3.0 mil thick, and more preferably about 2.5 mils.

The first major surface 30 of the liner 28 supports a differential release film 34 comprised of a silica or silicone material. An exemplary formulation for the film 34 is silocone material providing a differential release of ≧60 g./in. In addition, non-silicone release materials are also available and suitable for use as a release film.

The opposite, second major surface 32 of the liner 28 supports a silicone based film 36 having a release of ≦60 g./in². A preferred material is Rhodia 620 UV Silicone.

The liner 14 facilitates providing the transfer tape 10 in a roll form. In a roll, the silicone based film 36 contacts the aggressive adhesive 22 while the differential release film 34 is in contact with the repositionable adhesive 26. That way, as the roll of tape is being unwound, the silicone based film 36 releases from the aggressive adhesive 22 of the next adjacent turn on the roll. After a sufficient amount of the transfer tape 10 has been unwound, it is cut from the roll. Then, the face sheet system 12 is released from the differential release film 34. The piece of transfer tape has the exposed aggressive adhesive layer 22 and the repositionable adhesive layer 26. This tape is then useful for adhering the aggressive adhesive layer 22 to a support such as a placard or like support structure where the contact is intended to be permanent. The repositionable adhesive layer 22 is contacted to a second support surface. If the position of the placard to the second support surface is not exactly precise, the present transfer tape provides for removal and repositioning of the placard and the like thereto.

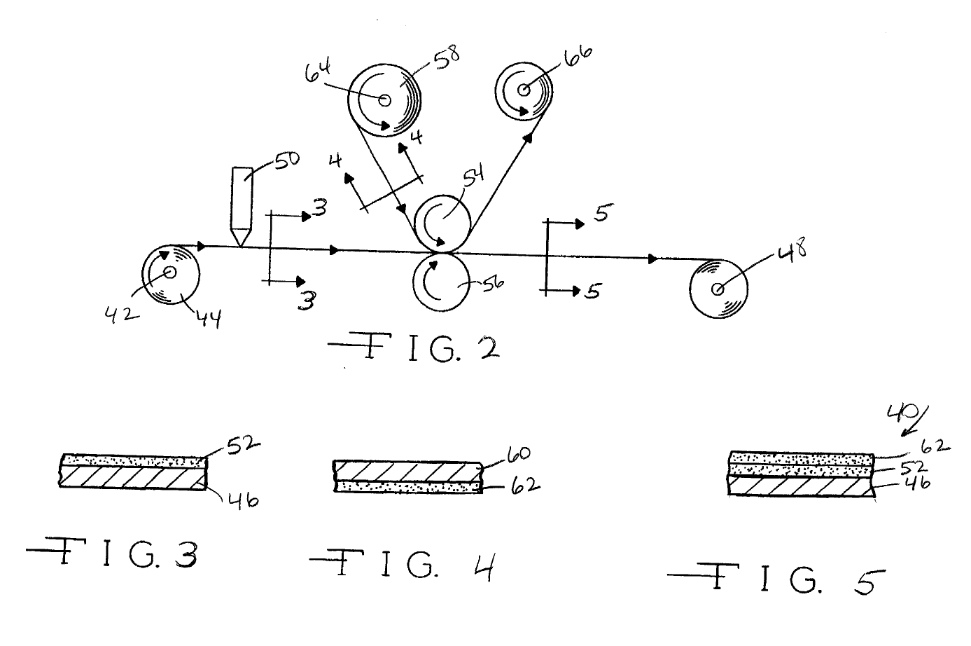

Referring now to FIGS. 2 to 5, there is shown a process for manufacturing a second embodiment of a transfer tape 40 according to the present invention. Beginning on the left hand side of FIG. 2, there is shown a spindle 42 supporting a bolt or roll 44 of release liner film 46. The roll 44 unwinds from spindle 42 and is rolled up on a take-up spindle 48. As the release liner 46 unwinds from spindle 42 it passes under a dispenser 50 of a low tack adhesive 52 (FIG. 3). This assembly then passes between a pair of counter rollers 54 and 56 before being wound up on the take-up spindle 48. Separately, a bolt 58 of a release liner 60 supporting an aggressive tack adhesive 62 unwinds from spindle 64 and passes between the counter rollers 54 and 56 before being wound up on a take-up spindle 66. As the assembly unrolling from the spindle 42 travels between the counter rollers 54 and 56, the aggressive tack adhesive 62 contacts the low tack adhesive 52 supported on the release liner 46 (FIG. 5). The aggressive tack adhesive 62 releases from the liner 60 and is supported on the low tack adhesive (FIG. 4) while the liner is wound up on the take-up spindle 66. The tape assembly shown in FIG. 5 thus comprises an aggressive tack adhesive 62 supported on a low tack or repositionable adhesive 52 contacting the carrier 46.

This assembly is referred to as a double-sided transfer tape and is useful, for example, in applications where the permanent adhesive contacts a support structure while the repositionable adhesive contacts a structure or device intended to be removed therefrom without their being any adhesive left behind. An example is a credit or debit card mailing. In this application, the aggressive adhesive contacts a mailer card while the credit card contacts the low tack adhesive 52. That way, the credit card is easily removed for use without there being residual adhesive on the credit card. The mailer card is then discarded in an acceptable manner.

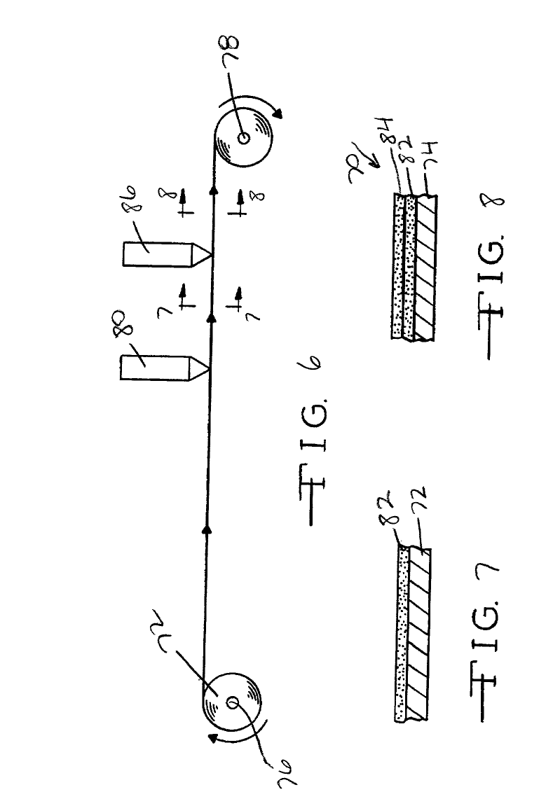

FIGS. 6 to 8 show another process for the manufacture of a double-sided transfer tape 70 according to the present invention. The process begins with a bolt 72 of the release liner system 74 being unwound from a spindle 76 and being wound up on a take-up spindle 78. Between the spindles, a first dispenser 80 deposits a low tack, repositionable adhesive 82 on the release liner system. The repositionable adhesive 82 is then over coated by an aggressive tack adhesive 84 deposited by dispenser 86.

The transfer tape 70 is particularly applicable in press on or tip on applications. In such applications, the tape is moved over an edge with the release liner system 74 facing downward. As the tape travels over the edge, the release liner 74 is pulled downwardly at a sharper angle than the adhesive layers 82, 84. This causes the adhesive layers 82, 84 to separate from the release liner 74. A knife (not shown) cuts the adhesive layers 82, 84 in a prescribed length and a jet of air and the like applies the repositionable adhesive 82 down onto a substrate as a support surface, such as a credit card and the like. The process continues with the aggressive adhesive contacting a second support structure, such as a mailer for sending the credit card to a customer. When the customer receives the mailer, he removes the credit card from the mailer for later use, and disposes of the mailer in an acceptable manner.

It is appreciated that various modifications to the present inventive concepts described herein may be apparent to those of ordinary skill in the art without departing from the spirit and scope of the present invention as defined by the herein appended claims.

What is claimed is:

1. A transfer tape, which comprises:
a) carrier;
b) a repositionable adhesive contacted to a first major surface of the carrier; and
c) an aggressive adhesive contacted to a second major surface of the carrier.

2. The transfer tape of claim 1 wherein the repositionable adhesive has a loop tack of ≦30 oz/in² and the aggressive adhesive has a loop tack of ≧30 oz./in².

3. The transfer tape of claim 1 wherein the repositionable adhesive has a loop tack of about 7 oz/in² to about 10 oz./in².

4. The transfer tape of claim 1 wherein the aggressive adhesive has a loop tack of about 80 oz./in² to about 100 oz/in².

5. The transfer tape of claim 1 wherein the repositionable adhesive is of an acrylic or latex based adhesive.

6. The transfer tape of claim 1 further including a tie coat intermediate the carrier and the repositionable adhesive.

7. The transfer tape of claim 1 wherein the aggressive adhesive is selected from the group consisting of a water based, a solvent based and a hot melt adhesive.

8. The transfer tape of claim 1 in a roll form and having a liner system positioned between the removable adhesive of a first layer of tape and the aggressive adhesive of a second layer of the tape.

9. The transfer tape of claim 1 wherein the liner system includes a substrate having a first silicone-based film contacted to a first major surface of the substrate and to the repositionable adhesive, and a second silicone-based film contacted to a second major surface of the substrate.

10. The transfer tape of claim 9 wherein the first silicone-based film has a differential release of ≧60 g/in. and the second silicone-based film has a differential release of ≦60 g./in.

11. A transfer tape, which comprises:
a) a carrier;
b) one of a repositionable adhesive and an aggressive adhesive contacted to a first major surface of the carrier; and
c) the other of the repositionable adhesive and the aggressive adhesive contacted to the one of the repositionable adhesive and the aggressive adhesive.

12. The transfer tape of claim 11 wherein the carrier is of a silicone-based film and the aggressive adhesive is contacted thereto with the repositionable adhesive contacted to the aggressive adhesive.

13. The transfer tape of claim 11 wherein the carrier is selected from the group of a polyolefin and a papermaterial, and the repositionable adhesive is contacted to the carrier with the aggressive adhesive contacted to the repositional adhesive.

14. The transfer tape of claim 11 wherein the repositionable adhesive has a loop tack of ≦30 oz/in² and the aggressive adhesive has a loop tack of ≧30 oz./in².
